(19) United States
(12) Patent Application Publication
(10) Pub. No.: US 2025/0106694 A1
(43) Pub. Date: Mar. 27, 2025

(54) SYSTEMS AND METHODS FOR CONTROLLING A RADIO ACCESS NETWORK USING ONE OR MORE CONTROLS

(71) Applicant: Verizon Patent and Licensing Inc., Basking Ridge, NJ (US)

(72) Inventors: Jin YANG, Orinda, CA (US); Viviana RIVERA TORRICO, Mission Viejo, CA (US); Cindy Yuexin DONG, Bridgewater, NJ (US); Vidya KRISHNAMURTHY, Edgewater, NJ (US); Steven F. RICE, Keller, TX (US)

(73) Assignee: Verizon Patent and Licensing Inc., Basking Ridge, NJ (US)

(21) Appl. No.: 18/473,677

(22) Filed: Sep. 25, 2023

(51) Int. Cl. H04W 28/24

(52) U.S. Cl. CPC H04W 28/24

(57) ABSTRACT

In some implementations, a radio access network (RAN) intelligent controller (RIC) associated with a core network may identify one or more controls for controlling a RAN at two or more of a cell level, a slicing level, a user equipment (UE) grouping level, or a quality of service (QOS) level. The RIC may transmit, to one or more of a radio unit (RU) associated with the RAN, a distributed unit (DU) associated with the RAN, a centralized unit (CU) associated with the RAN, or a network management system (NMS), signaling associated with the one or more controls.

### BACKGROUND

Wireless communication systems are widely deployed to provide various telecommunication services such as telephony, video, data, messaging, and broadcasts. A wireless network may include one or more network nodes that support communication for wireless communication devices.

### BRIEF DESCRIPTION OF THE DRAWINGS

FIG. 1 is a diagram of an example associated with controlling a radio access network (RAN) using one or more controls.

FIG. 2 is a diagram of an example associated with a multi-dimensional RAN intelligent controller (RIC).

FIG. 3 is a diagram of an example associated with a multi-dimensional RIC in an open radio access network (O-RAN) architecture.

FIG. 4 is a diagram of an example environment in which systems and/or methods described herein may be implemented.

FIG. 5 is a diagram of example components of one or more devices of FIG. 4.

FIG. 6 is a flowchart of an example process associated with controlling a RAN using one or more controls.

### DETAILED DESCRIPTION OF EXAMPLE EMBODIMENTS

The following detailed description of example implementations refers to the accompanying drawings. The same reference numbers in different drawings may identify the same or similar elements.

A radio access network (RAN) intelligent controller (RIC) may be a software-defined component of an open RAN (O-RAN) architecture. The RIC may be responsible for controlling and optimizing RAN functions. The RIC may provide multi-vendor operability and programmability to RANs. The RIC may enable the onboarding of third-party applications that automate and optimize RAN operations at scale while supporting use cases that lower a mobile operator's cost of ownership and enhance a customer's quality of service (QOS). The RIC may be able to execute various applications for mobility management, admission control, and/or interference management. The RIC may provide control functionalities, which may deliver increased efficiency and better radio resource management. The control functionalities may leverage analytics and data-driven approaches, including artificial learning and/or machine learning (AI/ML) tools, to improve resource management capabilities.

The RIC may include a non-real-time RIC and a near real-time RIC. A non-real-time RIC functionality may include configuration management, device management, fault management, performance management, and/or lifecycle management for network elements. The near-real-time RIC may be a near-real-time, micro-service-based software platform for hosting micro-service-based applications (xApps).

Various RAN intelligent controls have been defined in an O-RAN specification in terms of non-real-time, near real-time, and real-time. The various RAN intelligent controls may be defined at a cell level. However, a service level agreement (SLA) may be challenging to meet without additional dimensions defined for the RAN intelligent controls. For example, when RAN intelligent controls at only the cell level are used, certain SLAs for latency, throughput, and/or data rate may be unable to be satisfied, which may degrade an overall system performance.

In some implementations, a systematic approach with multiple dimensional (multi-dimensional) RAN intelligent controls may be employed to control a RAN at a cell level, a slicing level, a user equipment (UE) grouping level, and/or a QoS level. The RAN intelligent controls at each level (e.g., cell, slicing or UE grouping, and/or QoS) may be at non-real-time, near-real-time, and/or real-time, with different time resolutions. A time resolution associated with non-real-time may be greater than or equal to about one second. A time resolution associated with near-real-time may be greater than or equal to about 10 milliseconds (ms) and less than one second. A time resolution associated with real-time may be less than about 10 ms. The RAN intelligent controls at the multiple levels may be iterated to achieve an optimized SLA.

In some implementations, by defining the multi-dimensional RAN intelligent controls to control the RAN at the cell level, the slicing level, the UE grouping level, and/or the QoS level, certain SLAs for latency, throughput, and/or data rate may be more likely to be satisfied, which may improve an overall system performance. In other words, an SLA fulfillment may be more likely when the multi-dimensional RAN intelligent controls are available, which may improve the overall system performance.

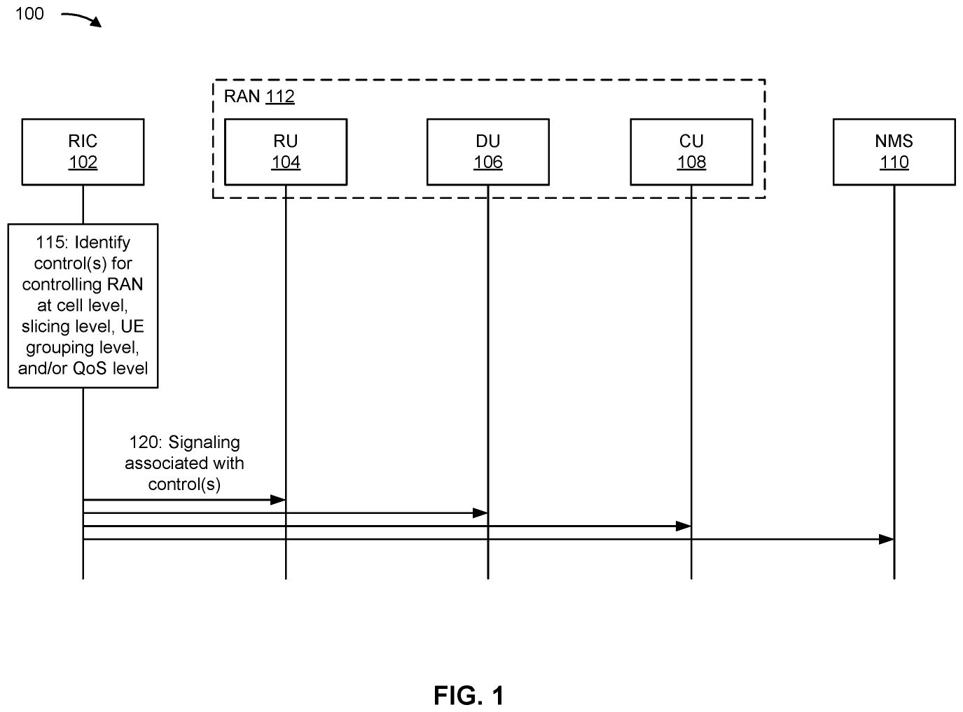

FIG. 1 is a diagram of an example 100 associated with controlling a RAN 112 using one or more controls. As shown in FIG. 1, example 100 includes a RIC 102, a radio unit (RU) 104, a distributed unit (DU) 106, a central unit (CU) 108, and a network management system (NMS) 110. The RU 104, the DU 106, and the CU 108 may be associated with a disaggregated network node. The disaggregated network node may be associated with the RAN 112. The RIC 102 and/or the NMS 110 may be in a core network. The RIC 102 may be broken into one or more separate units, such as a non-real time RIC, a near-real-time RIC, and/or a real-time RIC. The non-real time RIC, the near-real-time RIC, and/or the real-time RIC may be associated with different entities of the core network.

As shown by reference number 115, the RIC 102 may identify one or more controls for controlling the RAN 112 at a cell level, a slicing level, a UE grouping level, and/or a QoS level. The RIC 102 may be a multi-dimensional RIC capable of applying controls at multiple levels. A control may be applied at a per cell level. For example, different controls may be associated with different cells. A control may be applied at a per network slice level. For example, different controls may be associated with different network slices. A control may be applied at a per UE group level. For example, different controls may be associated with different UE groups. A control may be applied at a per QoS level. For example, different controls may be associated with different QoSs.

In some implementations, one or more controls may be associated with a time resolution, which may indicate a period of time for a control to be applied to the RAN 112. The time resolution may be a first time resolution, a second time resolution, or a third time resolution. The first time resolution may be associated with non-real-time. For example, the first time resolution may be associated with a time greater than about one second. The second time resolution may be associated with near-real-time. For example, the second time resolution may be associated with a time greater than or equal to about 10 ms and less than about one second. The third time resolution may be associated with real-time. For example, the third time resolution may be associated with a time less than about 10 ms. The one or more controls may be defined in an O-RAN in terms of time resolution (e.g., non-real-time, near-real-time, or real-time). A control at each level (e.g., cell level, slicing or UE grouping level, and/or QoS level) may be at non-real-time, near-real-time, and real-time, with different time resolutions.

As shown by reference number 120, the RIC 102 may transmit, to the RU, the DU, the CU, and/or the NMS, signaling associated with the one or more controls. The signaling may indicate a RAN parameter, which may be associated with the one or more controls. The RAN parameter may be based on a function of an adjustment at the cell level, an adjustment at the slicing or UE grouping level, and an adjustment at the QoS level. The RAN parameter may be based on a first weight associated with the cell level, a second weight associated with the slicing or UE grouping level, or a third weight associated with the QoS level. The RU, the DU, the CU, and/or the NMS may apply the RAN parameter associated with the one or more controls. The RU, the DU, the CU, and/or the NMS may apply the RAN parameter to appropriate resources, depending on the type of RAN parameter. In some cases, the RU, the DU, the CU, and/or the NMS may each apply the same RAN parameter. In other cases, the RU, the DU, the CU, and/or the NMS may apply different RAN parameters. In other words, the RIC 102 may indicate different RAN parameters for each of the RU, the DU, the CU, and/or the NMS. By implementing the RAN parameter, which may be based on the cell level, the slicing or UE grouping level, and/or the QoS level, an SLA may be able to be achieved in the RAN 112. The SLA may be associated with a certain latency, throughput, and/or data rate to be achieved in the RAN 112.

In some implementations, the RIC 102 may employ a multi-dimensional RAN intelligent control having three control loops at the cell level, the slice or UE grouping level, and the QoS level, respectively. The RIC 102 may define and/or adjust a RAN parameter. The RAN parameter may be defined in accordance with: Pₜ=Pₜ₋₁+f(Pcₜ₋₁+Psₜ₋₁+Pqₜ₋₁), where Pₜ is a parameter at time t. The RAN parameter may be defined based on a time t−1 and a function, where the function is based on an adjustment at a cell level Pcₜ₋₁, an adjustment at a slice or UE grouping level Psₜ₋₁, and an adjustment at a QoS level Pqₜ₋₁. The RAN parameter may be a function of the cell level, the slice or UE grouping level, and the QoS level. The RAN parameter may be the function of all three levels. Different levels may be associated with different weights. For example, the cell level may be associated with a first weight, the slice or UE grouping level may be associated with a second weight, and the QoS level may be associated with a third weight. The first weight, the second weight, and the third weight may be associated with a same weight or different weights.

In some implementations, the RIC 102 may iteratively perform the multi-dimensional RAN intelligent control at various resolutions. At the cell level, a cell level RAN parameter (P_{ct}) may be in accordance with: P_{ct}=P_{c(t-1)}+f_{c}(Pcₜ₋₁+Psₜ₋₁+Pqₜ₋₁), where the cell level RAN parameter may be defined based on a time c(t−1) and a cell-level function f_{c}. A multi-dimensional RAN intelligent control may be skipped when a resolution is, at a cell level, P_{ct}=P_{c(t-1)}+f_{c}(Pcₜ₋₁+Psₜ₋₁+Pqₜ₋₁) at every cell time resolution (Tcell). At the slice or UE grouping level, a slice or UE grouping level RAN parameter (Pₛₜ) may be in accordance with: Pₛₜ=Pₛ₍ₜ₋₁₎+fₛ(P_{ct}+Psₜ₋₁+Pqₜ₋₁), where the slice or UE grouping level RAN parameter may be defined based on a time s (t-1) and a cell-level function fₛ. A multi-dimensional RAN intelligent control may be skipped when a resolution is, at a slice or UE grouping level, Pₛₜ=Pₛ₍ₜ₋₁₎+fₛ(Pcₜ+Psₜ₋₁+Pqₜ₋₁) at every slicing time resolution (Tslicing). At the QoS level, a QoS level RAN parameter (P_{qt}) may be in accordance with: P_{qt}=P_{q(t-1)}+f_{q}(Pcₜ+Psₜ+Pqₜ₋₁), where the QoS level RAN parameter may be defined based on a time q(t−1) and a cell-level function f_{q}. A multi-dimensional RAN intelligent control may be skipped when a resolution is, at a QoS level, P_{qt}=P_{q(t-1)}+f_{q}(Pcₜ+Psₛₜ+Pqₜ₋₁) at every QoS time resolution (Tqos). Further, a multi-dimensional RAN intelligent control at any dimension (e.g., cell, slice or UE grouping, or QoS) may be skipped when a time trigger is not reached.

As an example, the one or more controls may be associated with a traffic steering and load balancing. The one or more controls may be associated with power, bands, and/or antenna tilting at the cell level. The one or more controls may be associated with a DU-CU allocation at the slicing level or the UE grouping level. The one or more controls may be associated with a cell individual offset (CIO) or a QoS offset at the QoS level.

In some implementations, by defining multi-dimensional RAN intelligent controls to control the RAN at the cell level, the slicing level, the UE grouping level, and/or the QoS level, certain SLAs for latency, throughput, and/or data rate may be more likely to be satisfied, which may improve an overall system performance. In other words, an SLA fulfillment may be more likely when the multi-dimensional RAN intelligent controls are available, which may improve the overall system performance.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

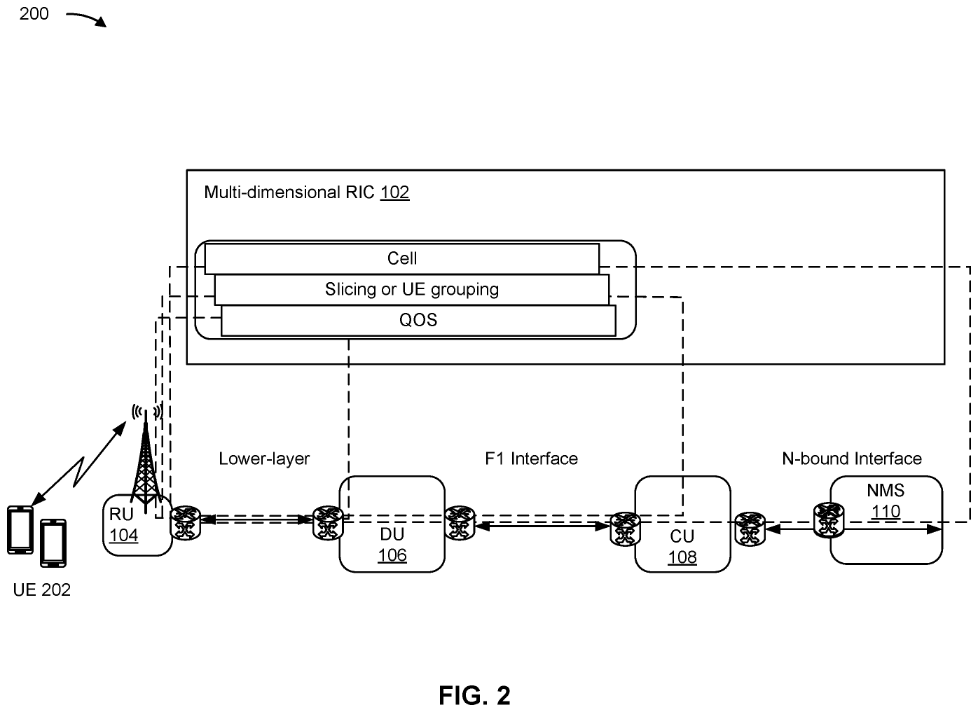

FIG. 2 is a diagram of an example 200 associated with a multi-dimensional RIC. As shown in FIG. 2, example 200 includes a UE 202, a RIC 102, an RU 104, a DU 106, a CU 108, and an NMS 110. The RU 104, the DU 106, and the CU 108 may be associated with a disaggregated network node. The DU 106 may be a baseband unit (BBU) DU. The CU 108 may be a BBU CU.

As shown in FIG. 2, the RIC 102 may be configured to communicate with the RU 104, the DU 106, the CU 108, and/or the NMS 110, which may allow the RIC 102 to perform multi-dimensional RAN intelligent controls at a cell level, a slicing level, a UE grouping level, and/or a QoS level. The RU 104 may be configured to communicate with the UE 202 (or multiple UEs). The RIC 102 may be associated with a core network.

As an example, the RIC 102 may be configured to implement traffic steering and load balancing. At the cell level, the RIC 102 may determine cell level related RAN parameters associated with power, bands, and/or remote electrical tilt (RET) (associated with antenna steering). At the slicing level, the RIC 102 may determine slicing level related RAN parameters associated with a DU-CU allocation. At the QoS level, the RIC 102 may determine QoS level related RAN parameters associated with a cell individual offset (CIO) and/or a QoS class identifier (QCI) offset (qoffset). The RIC 102 may determine the cell level related RAN parameters, the slicing level related RAN parameters, and/or the QoS level related RAN parameters, and the RIC 102 may indicate such RAN parameters to the RU 104, the DU 106, the CU 108, and/or the NMS 110. The RU 104, the DU 106, the CU 108, and/or the NMS 110 may each apply the cell level related RAN parameters, the slicing level related RAN parameters, and/or the QoS level related RAN parameters, which may improve the traffic steering and load balancing at the RU 104, the DU 106, the CU 108, and/or the NMS 110.

As indicated above, FIG. 2 is provided as an example. Other examples may differ from what is described with regard to FIG. 2.

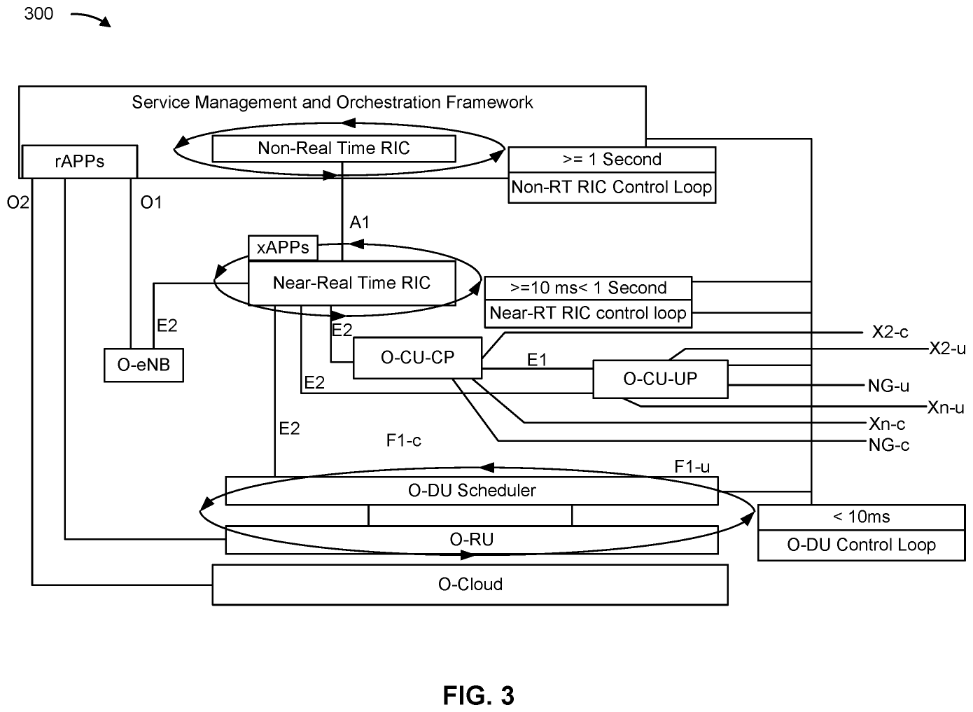

FIG. 3 is a diagram of an example 300 associated with a multi-dimensional RIC in an O-RAN architecture.

As shown in FIG. 3, an O-RAN architecture may include a service management and orchestration framework, an O-RAN gNB (O-gNB), and an O-RAN cloud (O-Cloud). The O-gNB may be associated with an O-RAN CU control plane (O-CU-CP) and an O-RAN CU user plane (O-CU-UP). The O-gNB may be associated with an O-RAN DU (O-DU) scheduler and an O-RAN RU (O-RU). The service management and orchestration framework may be associated with a non-real-time RIC. The non-real-time RIC may be associated with a non-real-time RIC control loop, which may be associated with a time resolution of greater than or equal to one second. A non-real-time control for slicing or QoS may be associated with a time resolution of more than one second. The non-real-time RIC may be associated with non-real-time applications (rApps). The O-RAN architecture may include a near-real-time RIC. The near-real-time RIC may be associated with a near-real-time RIC control loop, which may be associated with a time resolution of greater than or equal to about 10 ms and less than one second. A near-real-time control for routing may be associated with a time resolution of about 100 ms. A near-real-time control for scheduling handover may be associated with a time resolution of about 10 ms. The near-real-time RIC may be associated with xApps. The O-DU scheduler and the O-RU may be associated with a real-time RIC control loop, which may be associated with a time resolution of less than 10 ms. A real-time control (e.g., an O-DU control) for beamforming massive multiple-input, multiple-output (MIMO) may be associated with a time resolution of about 1 ms.

As indicated above, FIG. 3 is provided as an example. Other examples may differ from what is described with regard to FIG. 3.

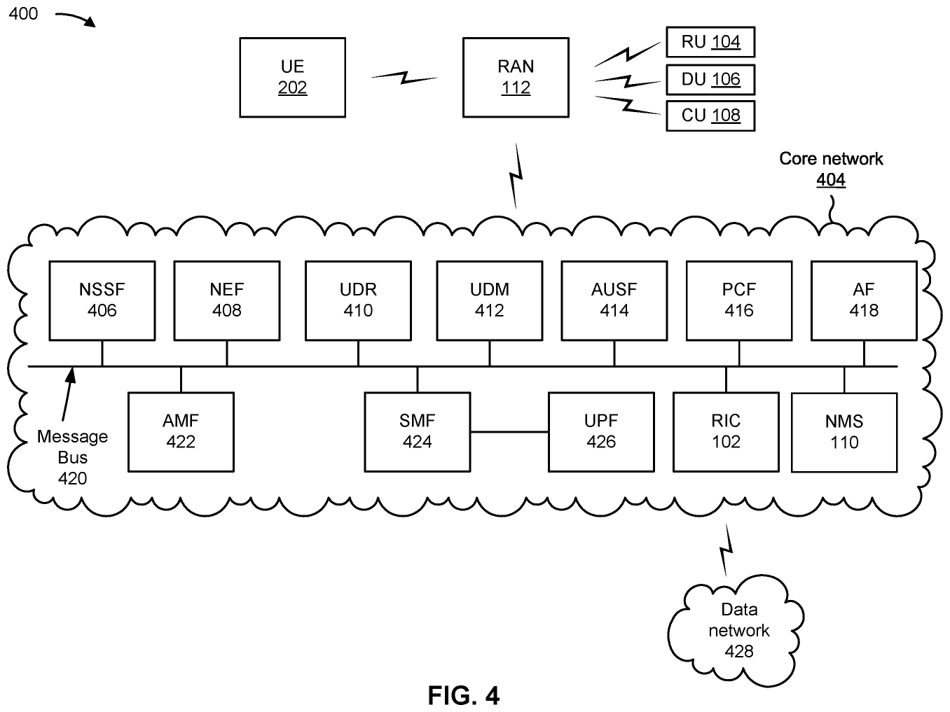

FIG. 4 is a diagram of an example environment 400 in which systems and/or methods described herein may be implemented. As shown in FIG. 4, example environment 400 may include a user equipment (UE) 202, a radio access network (RAN) 112, a core network 404, and a data network 428. Devices and/or networks of example environment 400 may interconnect via wired connections, wireless connections, or a combination of wired and wireless connections.

The UE 202 may include one or more devices capable of receiving, generating, storing, processing, and/or providing information, such as information described herein. For example, The UE 202 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 112 may support, for example, a cellular radio access technology (RAT). The RAN 112 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 202. The RAN 112 may be an O-RAN. A base station in the O-RAN may be a disaggregated base station. The disaggregated base station may be configured to utilize a protocol stack that is physically or logically distributed among two or more nodes, which may include an RU 104, a DU 106, and a CU 108. The RAN 112 may transfer traffic between the UE 202 (e.g., using a cellular RAT), one or more base stations (e.g., using a wireless interface or a backhaul interface, such as a wired backhaul interface), and/or the core network 404. The RAN 112 may provide one or more cells that cover geographic areas.

In some implementations, the RAN 112 may perform scheduling and/or resource management for the UE 202 covered by the RAN 112 (e.g., the UE 202 covered by a cell provided by the RAN 112). In some implementations, the RAN 112 may be controlled or coordinated by a network controller, which may perform load balancing, network-level configuration, and/or other operations. The network controller may communicate with the RAN 112 via a wireless or wireline backhaul. In some implementations, the RAN 112 may include a network controller, a self-organizing network (SON) module or component, or a similar module or component. In other words, the RAN 112 may perform network control, scheduling, and/or network management functions (e.g., for uplink, downlink, and/or sidelink communications of the UE 202 covered by the RAN 112).

In some implementations, the core network 404 may include an example functional architecture in which systems and/or methods described herein may be implemented. For example, the core network 404 may include an example architecture of a fifth generation (5G) next generation (NG) core network included in a 5G wireless telecommunications system. While the example architecture of the core network 404 shown in FIG. 4 may be an example of a service-based architecture, in some implementations, the core network 404 may be implemented as a reference-point architecture and/or a 4G core network, among other examples.

As shown in FIG. 4, the core network 404 include a number of functional elements. The functional elements may include, for example, a network slice selection function (NSSF) 406, a network exposure function (NEF) 408, a unified data repository (UDR) 410, a unified data management (UDM) 412, an authentication server function (AUSF) 414, a policy control function (PCF) 416, an application function (AF) 418, an access and mobility management function (AMF) 422, a session management function (SMF) 424, a user plane function (UPF) 426, a RIC 102, and/or an NMS 110. These functional elements may be communicatively connected via a message bus 420. Each of the functional elements shown in FIG. 4 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 406 may include one or more devices that select network slice instances for the UE 202. The NSSF 406 may allow an operator to deploy multiple substantially independent end-to-end networks potentially with the same infrastructure. In some implementations, each slice may be customized for different services. The NEF 408 may include one or more devices that support exposure of capabilities and/or events in the wireless telecommunications system to help other entities in the wireless telecommunications system discover network services.

The UDR 410 may include one or more devices that provide a converged repository, which may be used by network functions to store data. For example, a converged repository of subscriber information may be used to service a number of network functions. The UDM 412 may include one or more devices to store user data and profiles in the wireless telecommunications system. The UDM 412 may generate authentication vectors, perform user identification handling, perform subscription management, and perform other various functions. The AUSF 414 may include one or more devices that act as an authentication server and support the process of authenticating the UE 202 in the wireless telecommunications system.

The PCF 416 may include one or more devices that provide a policy framework that incorporates network slicing, roaming, packet processing, and/or mobility management, among other examples. The AF 418 may include one or more devices that support application influence on traffic routing, access to the NEF 408, and/or policy control, among other examples. The AMF 422 may include one or more devices that act as a termination point for non-access stratum (NAS) signaling and/or mobility management, among other examples. The SMF 424 may include one or more devices that support the establishment, modification, and release of communication sessions in the wireless telecommunications system. For example, the SMF 424 may configure traffic steering policies at the UPF 426 and/or may enforce UE internet protocol (IP) address allocation and policies, among other examples. The UPF 426 may include one or more devices that serve as an anchor point for intra-RAT and/or inter-RAT mobility. The UPF 426 may apply rules to packets, such as rules pertaining to packet routing, traffic reporting, and/or handling user plane QoS, among other examples.

The RIC 102 may include one or more devices that multi-dimensional RAN controls to control the RAN 112 at a cell level, a slicing level, a UE grouping level, and/or a QoS level, as described herein. The NMS 110 may include one or more devices that provide a set of management functions to facilitate operations, administration, and/or maintenance of the RAN 112. The message bus 420 may represent a communication structure for communication among the functional elements. In other words, the message bus 420 may permit communication between two or more functional elements.

The data network 428 may include one or more wired and/or wireless data networks. For example, the data network 428 may include an IP multimedia subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of example environment 400 may perform one or more functions described as being performed by another set of devices of example environment 400.

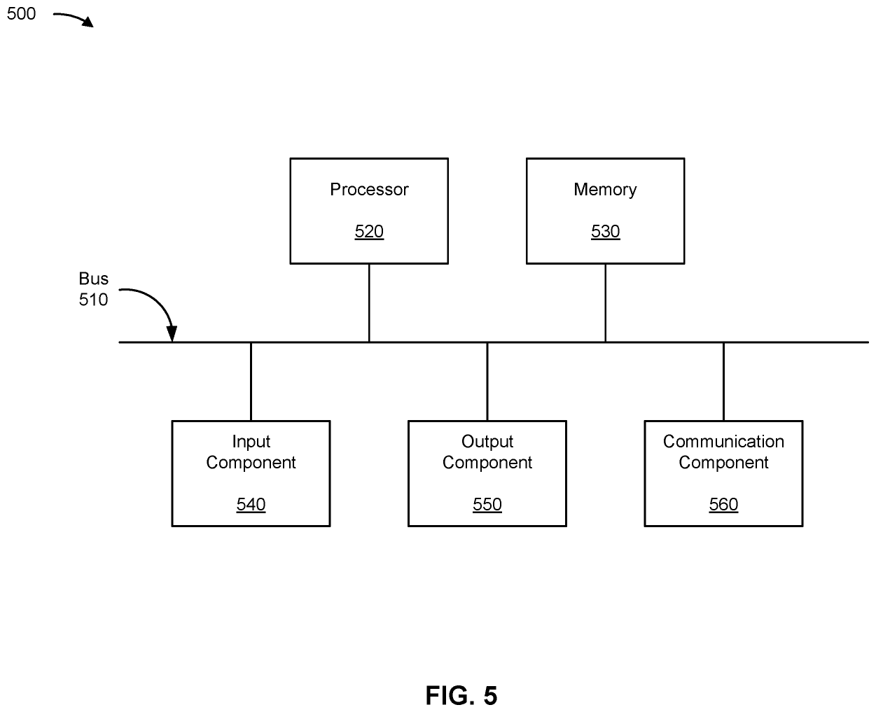

FIG. 5 is a diagram of example components of a device 500 associated with controlling a RAN using one or more controls. The device 500 may correspond to a RIC (e.g., RIC 102). In some implementations, the RIC 102 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

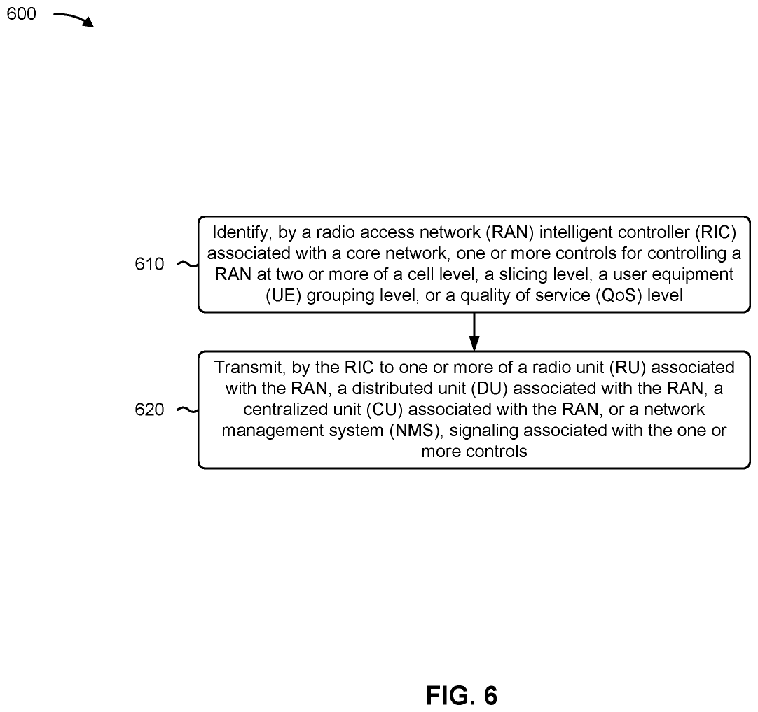

FIG. 6 is a flowchart of an example process 600 associated with controlling a RAN using one or more controls. In some implementations, one or more process blocks of FIG. 6 may be performed by a RIC (e.g., RIC 102). In some implementations, one or more process blocks of FIG. 6 may be performed by another device or a group of devices separate from or including the RIC, such as an RU (e.g., RU 104), a DU (e.g., DU 106), a CU (e.g., CU 108), or an NMS (e.g., NMS 110). The RU, the DU, and the CU may be associated with a RAN (e.g., RAN 112). Additionally, or alternatively, one or more process blocks of FIG. 6 may be performed by one or more components of device 500, such as processor 520, memory 530, input component 540, output component 550, and/or communication component 560.

As shown in FIG. 6, process 600 may include identifying one or more controls for controlling a RAN at two or more of a cell level, a slicing level, a UE grouping level, or a QoS level (block 610). The one or more controls may be associated with a first time resolution, a second time resolution, or a third time resolution. The first time resolution may be associated with non-real-time. The second time resolution may be associated with near-real-time. The third time resolution may be associated with real-time. As an example, the one or more controls may be associated with a traffic steering and load balancing within the RAN.

As shown in FIG. 6, process 600 may include transmitting, to one or more of the RU associated with the RAN, the DU associated with the RAN, the CU associated with the RAN, or an NMS, signaling associated with the one or more controls (block 620). The signaling associated with the one or more controls may indicate a RAN parameter. The RAN parameter may be based on a function of an adjustment at the cell level, an adjustment at the slicing or UE grouping level, and an adjustment at the QoS level. The RAN parameter may be based on a first weight associated with the cell level, a second weight associated with the slicing or UE grouping level, or a third weight associated with the QoS level. The RU, DU, the CU, and/or the NMS may apply the RAN parameter, which may enable a certain SLA to be achieved. For example, by applying the RAN parameter, an SLA associated with traffic steering and load balancing may be achieved within the RAN.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
identifying, by a radio access network (RAN) intelligent controller (RIC) associated with a core network, one or more controls for controlling a RAN at two or more of a cell level, a slicing level, a user equipment (UE) grouping level, or a quality of service (QOS) level; and
transmitting, by the RIC to one or more of a radio unit (RU) associated with the RAN, a distributed unit (DU) associated with the RAN, a centralized unit (CU) associated with the RAN, or a network management system (NMS), signaling associated with the one or more controls.

2. The method of claim 1, wherein the one or more controls are associated with a first time resolution, and the first time resolution is associated with non-real-time.

3. The method of claim 1, wherein the one or more controls are associated with a second time resolution, and the second time resolution is associated with near-real-time.

4. The method of claim 1, wherein the one or more controls are associated with a third time resolution, and the third time resolution is associated with real-time.

5. The method of claim 1, wherein the signaling associated with the one or more controls indicates a RAN parameter, and the RAN parameter is based on a function of an adjustment at the cell level, an adjustment at the slicing level, an adjustment at the UE grouping level, and an adjustment at the QoS level.

6. The method of claim 1, wherein the signaling associated with the one or more controls indicates a RAN parameter, and the RAN parameter is based on a first weight associated with the cell level, a second weight associated with the slicing or UE grouping level, or a third weight associated with the QoS level.

7. The method of claim 1, further comprising:
providing a service level agreement (SLA) based on the one or more controls.

8. The method of claim 1, wherein:
the one or more controls are associated with:
a traffic steering and load balancing;
one or more of power, bands, or antenna tilting at the cell level;
a DU-CU allocation at the slicing or UE grouping level; or
a cell individual offset (CIO) or a QoS offset at the QoS level.

9. A radio access network (RAN) intelligent controller (RIC), comprising:
one or more processors configured to:
identify one or more controls for controlling a RAN at two or more of a cell level, a slicing level, a user equipment (UE) grouping level, or a quality of service (QOS) level; and
transmit, to one or more of a radio unit (RU) associated with the RAN, a distributed unit (DU) associated with the RAN, a centralized unit (CU) associated with the RAN, or a network management system (NMS), signaling associated with the one or more controls.

10. The RIC of claim 9, wherein the one or more controls are associated with a first time resolution, and the first time resolution is associated with non-real-time.

11. The RIC of claim 9, wherein the one or more controls are associated with a second time resolution, and the second time resolution is associated with near-real-time.

12. The RIC of claim 9, wherein the one or more controls are associated with a third time resolution, and the third time resolution is associated with real-time.

13. The RIC of claim 9, wherein the signaling associated with the one or more controls indicates a RAN parameter, and the RAN parameter is based on a function of an adjustment at the cell level, an adjustment at the slicing or UE grouping level, and an adjustment at the QoS level.

14. The RIC of claim 9, wherein the signaling associated with the one or more controls indicates a RAN parameter, and the RAN parameter is based on a first weight associated with the cell level, a second weight associated with the slicing or UE grouping level, or a third weight associated with the QoS level.

15. The RIC of claim 9, wherein the one or more processors are further configured to:
provide a service level agreement (SLA) based on the one or more controls.

16. The RIC of claim 9, wherein:
the one or more controls are associated with a traffic steering and load balancing;
the one or more controls are associated with one or more of power, bands, or antenna tilting at the cell level;
the one or more controls are associated with a DU-CU allocation at the slicing or UE grouping level; or
the one or more controls are associated with a cell individual offset (CIO) or a QoS offset at the QoS level.

17. A non-transitory computer-readable medium storing a set of instructions, the set of instructions comprising:
one or more instructions that, when executed by one or more processors of a device, cause the device to:
identify one or more controls for controlling a radio access network (RAN) at two or more of a cell level, a slicing level, a user equipment (UE) grouping level, or a quality of service (QOS) level; and
transmit, to one or more of a radio unit (RU) associated with the RAN, a distributed unit (DU) associated with the RAN, a centralized unit (CU) associated with the RAN, or a network management system (NMS), signaling associated with the one or more controls.

18. The non-transitory computer-readable medium of claim 17, wherein:
the one or more controls are associated with:
a first time resolution associated with non-real-time;
a second time resolution associated with near-real-time; or
a third time resolution associated with real-time.

19. The non-transitory computer-readable medium of claim 17, wherein the signaling associated with the one or more controls indicates a RAN parameter, the RAN parameter is based on a function of an adjustment at the cell level, an adjustment at the slicing or UE grouping level, and an adjustment at the QoS level, and the RAN parameter is based on a first weight associated with the cell level, a second weight associated with the slicing or UE grouping level, or a third weight associated with the QoS level.

20. The non-transitory computer-readable medium of claim 17, wherein:
the one or more controls are associated with a traffic steering and load balancing;
the one or more controls are associated with one or more of power, bands, or antenna tilting at the cell level;
the one or more controls are associated with a DU-CU allocation at the slicing or UE grouping level; or
the one or more controls are associated with a cell individual offset (CIO) or a QoS offset at the QoS level.
